(19) United States
(12) Patent Application Publication
(10) Pub. No.: US 2026/0228038 A1
(43) Pub. Date: Aug. 6, 2026

(54) HIERARCHICAL MOVER SUBORDINATION SYSTEMS AND METHODS

(71) Applicant: ROCKWELL AUTOMATION TECHNOLOGIES, INC., Mayfield Heights, OH (US)

(72) Inventors: Yuhong Huang, Acton, MA (US); Paul Brooks, Everberg (BE); Jack M. Visoky, Willoughby, OH (US); Brian M. Perreault, Stow, MA (US); David D. Brandt, New Berlin, WI (US)

(73) Assignee: ROCKWELL AUTOMATION TECHNOLOGIES, INC., Mayfield Heights, OH (US)

(21) Appl. No.: 19/044,151

(22) Filed: Feb. 3, 2025

(51) Int. Cl. G06F 9/48

(52) U.S. Cl. CPC G06F 9/4875; G06F 2209/482

(57) ABSTRACT

Systems, methods, and apparatuses of hierarchical mover subordination are provided. The system can obtain an indication of a task, and can determine a parameter of the mover of the first category and a parameter of the mover of the second category. The system can assign, based on the parameter of the mover of the first category, the parameter of the mover of the second category, and the indication of the task, a first hierarchical ranking to the mover of the first categorasy and a second hierarchical ranking to the mover of the second category. The system can provide an instruction to the mover of the first category to execute the task, which can cause the mover of the first category to provide an instruction to the mover of the second category, to cause the mover of the second category to take an action.

### BACKGROUND

Vehicles can work with other vehicles to perform tasks.

### SUMMARY

At least one aspect is directed to system. The system can include one or more processors, coupled with memory, a mover of a first category, and a mover of a second category. The one or more processors can be configured (e.g., via instructions or data stored in memory and accessed and executed by the one or more processors) to obtain an indication of a task for execution by the mover of the first category and the mover of the second category. The one or more processors can be configured to determine a parameter of the mover of the first category and a parameter of the mover of the second category. The one or more processors can be configured to assign, based on the parameter of the mover of the first category, the parameter of the mover of the second category, and the indication of the task, a first hierarchical ranking to the mover of the first category and a second hierarchical ranking to the mover of the second category. The one or more processors can be configured to provide an instruction to the mover of the first category to execute the task, the instruction to the mover of the first category to execute the task to cause the mover of the first category to provide an instruction to the mover of the second category, to cause the mover of the second category to take an action.

This summary is illustrative and not intended to be limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The accompanying drawings are not intended to be drawn to scale. Like reference numbers and designations in the various drawings indicate like elements. For purposes of clarity, not every component can be labeled in every drawing. In the drawings:

FIG. 1 depicts an example system of hierarchical mover subordination.

FIG. 2 depicts an example system of hierarchical mover subordination.

FIG. 3 depicts an example method of hierarchical mover subordination.

FIG. 4 depicts an example schematic block diagram of a computing system.

### DETAILED DESCRIPTION

Before turning to the figures, which illustrate certain exemplary embodiments in detail, it should be understood that the present disclosure is not limited to the details or methodology set forth in the description or illustrated in the figures. The terminology used herein is for the purpose of description only and should not be regarded as limiting.

A mover as described herein can be programmed or setup to complete tasks. These movers can communicate with other movers in order to complete their tasks. Often times these movers are interacting with other movers of the same type. However, there may be times when a mover of a first category that works in one system needs to interact with a mover of a second category in another system for various reasons.

Movers can be configured to travel along the track to deliver loads of goods, materials, and other items. Movers can also be configured to move around an open space autonomously. Movers of one category may be a different shape, weigh differently, have a different speed, or have different constraints of movement, carrying capacity and vision as movers of a second category. Therefore, when these movers of one category are working with movers of a second category, it may be difficult for the movers to work well together, especially if some fault conditions occur. It may be a technical challenge for movers of one category to issue commands to a mover of a second category to follow and assist the mover of the first category due, for example, to a lack of an established supervisor/subordinate system, and different mover constraints. Therefore, if a mover of one category determines or is instructed to interact or pair with a mover of a second category, the pair may act in an inefficient manner due to lack of knowledge movers of different categories have regarding the constraints of other movers. This can lead to inefficiencies as a whole as other movers will be interrupted by inefficient paired movers.

To overcome these and other challenges, the technical solutions of the present disclosure implement advanced features such as obtaining an indication of a task for execution by the mover of the first category and the mover of the second category. By determining a parameter of the mover of the first category and a parameter of the mover of the second category, the system can assign hierarchical rankings to movers and provide instructions to a mover of a first category to execute a task and cause the mover of the first category to provide a second instruction to the mover of the second category to take an action. By determining parameters of movers before assigning hierarchical rankings and providing instructions, the system enables improved efficiency, improves coordination between movers, minimizes bottlenecks, and enhances overall throughput and productivity.

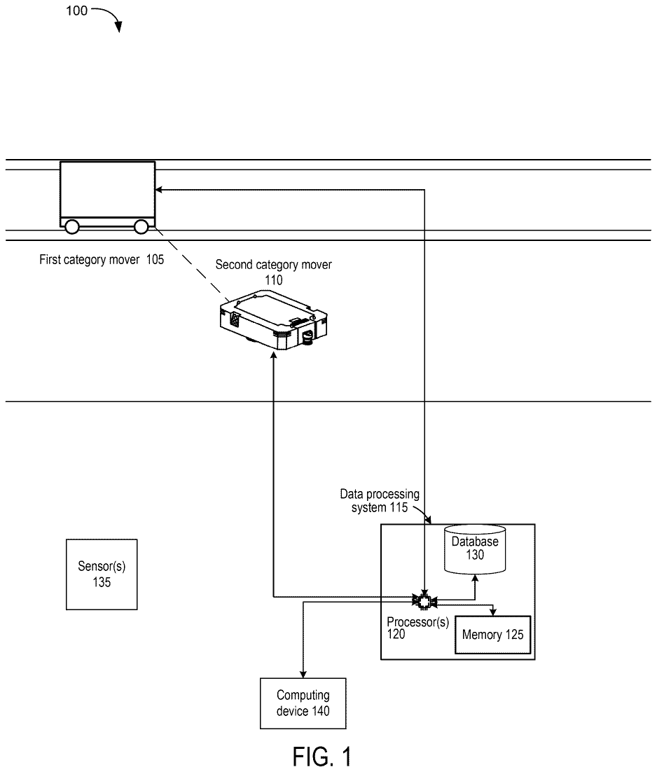

FIG. 1 depicts an example system 100 of hierarchical mover subordination. For example, the system 100 can enable a mover of a first category 105 to instruct a mover of a second category 110 to take an action.

The system 100 can include at least one data processing system 115. The data processing system 115 can include one or more processors 120 coupled with memory 125. Processor 120 can include any combination of hardware and software for processing instructions, such as instructions for providing functionalities of the data processing system 115 or data, such as the data of sensor 135, the mover of a first category 105, the mover of a second category 110, database 130, memory 125 or computing device 150. For example, the processor 120 can receive input data or instructions from a computing device 150. The processors 120 can be located in a programmable logic controller (PLC) or a high-level controller (HLC). The processor 120 can be or include a PLC or an HLC. The processors 120 can include mobile Processors, server Processors, embedded Processors (such as microcontrollers), multi-core Processors (including both single-core and multi-core variants), high-performance Processors, ARM Processors, x86 Processors, quantum Processors, FPGA-based Processors, graphics processing units (GPUs), digital signal processors (DSPs), artificial intelligence (AI) processors (such as neural processing units (NPUs) and tensor processing units (TPUs)), superscalar Processors, 64-bit Processors, hyper-threaded Processors, system-on-chip (SoC) Processors. The processor 120 may be located within a warehouse on a centralized controller or on a computing device 140 (i.e., mobile device, laptop, server, PC, etc.).

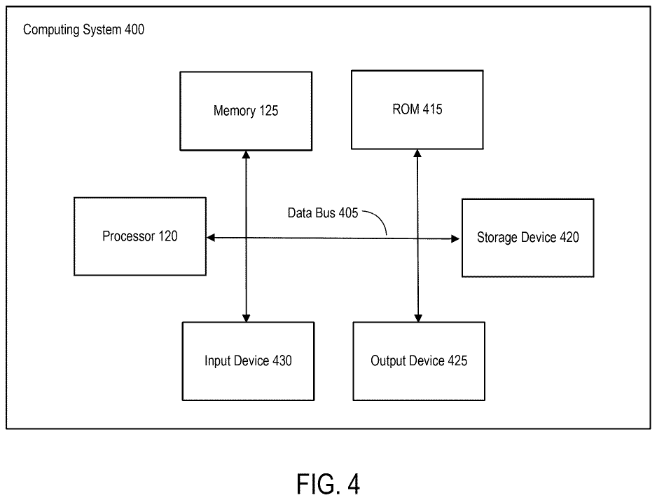

For example, at least one data processing system 115 can include one or more processor(s) 120 coupled with memory 125. The memory 125 can include RAM or ROM. The data processing system 115 can be located in a programmable logic controller (PLC), a high-level controller (HLC), a mover of the first category mover, or a mover of the second category. The processors 120 can provide memory to storage device 420 (e.g., of FIG. 4 among others) or retrieve memory storage from the storage device 420 (e.g., of FIG. 4 among others).

The system 100 can include at least one database 130. Database 130 can include any combination of hardware and software for storing data or information. The database 130 can include or utilize, for example, a storage device, such as, storage device 420 of FIG. 4. The database 130 can include, for example, various data structures for storing and relating various types and form of data utilized by the system 100. The database 130 can include and store, for example, data from the data processing system 115, data on first category movers 105, data on movers of a second category 110, as well as data from sensors 135. The database 130 can be part of the memory 125 or separate from the memory 125.

The system 100 can output to display by a computing device 150. For example, the computing device 150 can include or utilize, for example, an output device, such as, output device 425 of FIG. 4. Computing device 140 can include a computing device, a monitor, a server, a mobile device, a television, a Human-Machine Interface (HMI) panel.

Illustrated is at least one mover of a first category 105, also referred to herein as a first category mover 105 or a mover of the first category 105. The first category mover 105 can include any combination of hardware and software for transporting, guiding, or positioning payloads along a designated track. For example, the first category mover 105 can include an independent cart technology (ICT)-based mover, conveyor-based mover, automated guided vehicles (AGV), autonomous mobile robots, linear motor movers, automated guided vehicles (AGV) using linear synchronous motor (LSM) technology, or independent cart technology (ICT)-based mover using linear synchronous motor (LSM) technology. The first category mover 105 can include gliding or rolling contact with a track. The first category mover 105 can travel around a track. The first category mover 105 can independently move around the track. The first category mover 105 can move bidirectionally or unidirectionally around the track. The first category movers 105 can communicate with other first category movers 105. Multiple first category movers 105 can be present and in motion on the track concurrently, travelling to and from the same or different origins or destinations. The first category mover 105 can be programmed to be autonomous. First category movers 105 can include motors. The first category mover 105 can include a hall effect sensor. The first category mover 105 can magnetically glide across a track. The first category mover 105 can roll across a track. The first category mover 105 can have a unique id assigned to it. The system 100 can trace the unique ID of the first category mover 105. The first category mover 105 can include a Near Field Communication chip, a Bluetooth chip, a Bluetooth low energy chip, a radio frequency identification (RFID) chip, a Wi-fi chip, or a cellular chip. The data processing system 115 can use a camera to identify and track the first category mover 105. The data processing system 115 can measure the magnetic signature of the first category mover 105 to identify and trace the first category mover 105. The first category mover 105 can interact with the mover of a second category 110. The first category mover 105 can include a first local data processing system. The system 100 can include a plurality of first category movers 105. The first category mover 105 can include a mechanical engagement system such as a pin and socket in order to verify the first category mover 105 is aligned with another mover or machine. The first category mover 105 thrust can be disabled. The first category mover 105 can be or include the mover of a second category 110.

The system 100 can include at least one mover of a second category 110, also referred to herein as a second category mover 110 or a mover of the second category 110. Second category mover 110 can include any combination of hardware and software for transporting, maneuvering, or positioning objects such as payloads. The second category mover 110 can include an independent moving vehicle, automated guided vehicles (AGV), autonomous mobile robots (AMR), linear motor movers, or an automated guided vehicles (AGV) using linear synchronous motor (LSM) technology. The second category mover 110 can communicate with first category movers 105. The second category mover 110 communicate with other second category movers 110. The second category mover 110 can interact with a first category mover 105 while maintaining a minimum speed. The minimum speed can be a preset speed or the speed of other second category movers 110 in the vicinity. The second category mover 110 can interact with a robotic arm or a conveyor. Multiple second category movers 110 can interact with other second category movers 110. Second category movers 110 can interact with the first category mover 105. The second category mover 110 can include a conveyor. The second category mover 110 can include a robotic arm. The second category mover 110 can synchronize with the first category mover 105. The second category mover 110 can follow a mission between a start point and an end point. The second category mover 110 can be autonomous. The system 100 can include a plurality of second category movers 110. The second category mover 110 can include a pin or socket that can engage with the first category mover 105. The second category mover 110 can include a mechanical engagement system such as a pin and socket to verify the second category mover 110 is aligned with another mover or machine. The second category mover 110 can be autonomous or remote controlled. The second category mover 110 can synchronize with the first category mover 105. The second category mover 110 can be or include the first category mover 105.

The system 100 (e.g. data processing system 115 components such as the processor(s) 120) can select the mover of the first category 105 and the mover of the second category 110 based on the parameters that are sensed from the movers. The parameters sensed from the mover of the first category 105 and the mover of the second category 110 can include the locations of the movers, the battery levels of the movers, or whether the movers are already committed to a task. The parameters sensed from the mover of the first category 105 and the mover of the second category 110 can include the shape of the movers, the maximum speed of the movers, the weight of the movers, or the payload capabilities of the movers,

The system 100 (e.g. data processing system 115 components such as the processor(s) 120) can obtain at least one indication of a task for execution by the mover of the first category and the mover of the second category. For example, the system 100 can obtain the indication of a task for execution directly from the processor 120, from memory 125, or from database 130. For example, the system 100 can obtain the indication of a task for execution wirelessly or through a wired connection.

For example, the indication can include a command, instruction, a signal, data, or data representing a command or an instruction. The indication can include a command to the first category mover 105 and the second category mover 110 to perform an action together while in synchronized motion, a command to the first category mover 105, a command to the second category mover 110, or a command to both the first category mover 105 and the second category mover 110.

For example, the task for execution by the mover of the first category 105 and the mover of the second category 110 can include a task to arrive to a certain area within a time range. The time range can include a time period between 1 second and 10 seconds. The time range can include a time range that is calculated by the first category mover 105 or the second category mover 110. The time range can include a time range that is calculated by a processor 120. The time range can be based on the position of the first category mover 105, second category mover 110, or both the first category mover 105 and second category mover 110. The task for execution can include the mover of the first category 105 and the mover of the second category 110 carrying an object such as a payload from a point A to a point B, the first category mover 105 arriving to an area and the second category mover 110 arriving to a different area. The task for execution can include the first category mover 105 carrying an object to a location and the second category mover carrying an object to the same location while the first category mover 105 and the second category mover 110 are side by side or within a threshold distance of each other. The task for execution can include a series of instructions that cause the first category mover 105 to follow commands issued by the second category mover 110.

The system 100 (e.g. data processing system 115 components such as the processor(s) 120) can identify or select the mover of a first category 105 or the mover of the second category 110. For example, the system 100 can identify or select, based on the indication of the task, the mover of a first category 105 or the mover of the second category 110 for the task. The system 100 can retrieve or obtain a list of tasks from a database (e.g., database 130) or memory (e.g., memory 125) that particular movers are capable of completing and map or match such tasks to specific movers. The specific movers can include the mover of the first category 105 or the mover of the second category 110.

The system 100 can identify specific movers. For example, the specific movers can be movers with a specific amount of battery life remaining, a mover in the correct location at the right time, whether a mover is committed to a task already, the maximum speed of the mover, the shape of the mover, the capabilities of the mover, or a mover that has no payload currently. The selection criteria for specific movers can include parameters such as remaining battery life, appropriate location and timing, or the absence of a mover with a payload. The system 100 (e.g. data processing system 115 components such as the processor(s) 120) can determine at least one parameter of the first category mover 105 and at least one parameter of the second category mover 110. The system 100 can determine a parameter by analyzing data provided to it by sensor 135. The data provided to system 100 can include video data, image data, LiDAR data, weight data, telemetry data from the first category mover 105, telemetry data from the second category mover 110, environmental data of the environment the movers are in, infrared data, ultrasonic data, proximity data, object recognition data, or image processing data.

For example, the parameter of the first category mover 105 and the parameter of the second category mover 110 can include the shape of the first category mover 105, the shape of the second category mover 110, the maximum speed of the first category mover 105, the maximum speed of the second category mover 110, the weight of the first category mover 105, the weight of the second category mover 110, the location of the first category mover 105, the location of the second category mover 110, the speed of the first category mover 105, the speed of the second category mover 110, the capabilities of the first category mover 105, or the capabilities of the second category mover 110. The parameter of the first category mover 105 and the second category mover 110 can include the battery level of the first category mover 105, the battery level of the second category of movers 110, or the payload capabilities of the first category mover 105, or the payload capabilities of the second category mover 110. The capabilities of the first category mover 105 and second category mover 110 can include how fast the movers can go, the medium on which the movers travel, the amount of traction the movers have, the weight of the movers, the electronic sensors the movers are equipped with, the braking power of the movers, or the size of the movers.

The system 100 (e.g. data processing system 115 components such as the processor(s) 120) can assign, based on the parameter of the first category mover 105, the parameter of the mover of the second category, and the indication of the task, a first hierarchical ranking to the first category mover 105 and a second hierarchical ranking to the second category mover 110. For example, the system 100 can assign hierarchical rankings by assigning a unique ID to the first category mover 105 or the second category mover 110. For example, the system 100 can assign hierarchical rankings based on the comparison of the location parameter and speed parameter of the first category mover 105 and the second category mover 110. The system 100 can assign the hierarchical rankings based the comparison of the weight parameter and maximum speed parameter of the first category mover 105 and the second category mover 110. The system 100 can assign the hierarchical rankings based on the comparison of the shape parameter, weight parameter, and the maximum speed parameter of the first category mover 105 and the second category mover 110. The indication of the task can include a task to move an object on the first category mover 105 and a different object on a second category mover 110 from point A to point B where the first category mover 105 and the second category mover 110 have to remain within a threshold distance of each other. The indication of the task can include instructions for the mover of the first category 105 and the mover of the second category 110 to move an object from point A to point B. The indication of the task can include instructions for the mover of the first category 105 and the mover of the second category 110 to move from the mover of the first category 105 and the mover of the second category 110 respective areas to a point “A” and point “B” where point “A” represents the area where the first category mover 105 is assigned to move and point “B” represents where the second category mover 110 is assigned to move. The first hierarchical ranking can be assigned to the first category mover 105 or the second category mover 110. The second hierarchical ranking can be assigned to the second category mover 110. The first hierarchical ranking can indicate a supervisor position or a subordinate position. The second hierarchical ranking can indicate a supervisor or subordinate position. The hierarchical rankings can be signified by a unique identifier marked on the first category mover 105 or the second category mover 110. The system 100 can translate data from a mover of the first category 105 into data that is readable by a mover of a second category 110.

Illustrated is a sensor 135. Sensor 135 can include any combination of hardware and software for sensing or measuring data used by the example system 100. For example, sensor 135 can include devices, systems, components, or circuits for capturing or measuring signals indicative of presence, state, velocity, or any other characteristics of a vehicle such as a mover. Sensor 135 can include any combination of sensors or detector for capturing various analog or digital data. For example, sensor 135 can include radar sensors for measuring mover speed and distance, and lidar sensors for creating 3D maps of an area or detecting shapes and distances of various entities. Sensor 135 can include ultrasonic sensors configured for detection of movers at various distances from the sensors 135. Sensor 135 can include infrared sensors to detect thermal signatures of a mover. Sensor 135 can be a camera. Sensor 135 can include doppler radar sensors to measure entity speeds, or piezoelectric sensors to detect weight and speed. Sensor 135 can include an impact sensor, a pressure sensor, or an accelerometer-based sensor to detect movement, impacts, and mover accidents. Sensors 135 can include optical or fiber optic sensors for monitoring movement, velocity, or direction, as well as stress and strain on track surfaces. Sensor 135 can include laser rangefinders to measure distances and positions of movers. Sensor 135 can include vibration sensors to detect movement of objects, as well as accelerometers to measure the acceleration, deceleration, speed, and orientation of objects such as movers. Sensor 135 can include water detection sensors to detect presence of water. Sensor 135 can include gas sensors to detect gases (e.g., oxygen, carbon dioxide, methane). Sensor 135 can include barometric pressure sensors to measure atmospheric pressure. Sensor 135 can include a Near Field Communication sensor, a barcode scanner, a quick response (QR) code scanner, a Bluetooth chip, a Bluetooth sensor, a Bluetooth low energy sensor, a radio frequency The system 100 can assign hierarchical rankings by using sensor 135 to identify the shape of the first category mover 105 or the shape of the second category mover 110 and assigning the first category mover and the second category mover a hierarchical ranking linked or based on the shape identified of each the first category mover 105 and the second category mover 110.

For example, the system 100 can assign hierarchical rankings by linking a unique ID of the first category mover 105 and the second category mover 110 with a hierarchical rank. The system 100 can assign hierarchical rankings by using sensor 135 to identify and trace a magnetic signature, Wi-Fi signal, or other signal emitting from the first category mover 105 or the second category mover 110, and assign the signal, the mover of the first category 105, the mover of the second category 110, or the magnetic signature a unique ID based on the data received from sensor 135 regarding the magnetic signal or signal emitting from the first category mover 105 or the second category mover 110.

The system 100 (e.g. data processing system 115 components such as the processor(s) 120) can provide at least one instruction to the mover of the first category 105 to execute the task, the instruction to the mover of the first category 105 to execute the task to cause the mover of the first category 105 to provide an instruction to the mover of the second category 110, to cause the mover of the second category 110 to take at least one action. For example, the system 100 can provide the instructions using Wi-Fi, Bluetooth, near field communication, radio, Infrared, Zigbee, cellular, long range, Radio frequency identification, and Ultra-wideband signals. The instructions can include a signal, data, data representing an instruction, or a command. The instructions can be encrypted. Both the instructions can be digitally signed. The instructions can be sent to the first category mover 105 or the second category mover 110. The instructions can instruct the mover of the first category 105 to execute a task. The instruction to the mover of the first category 105 can cause the mover of the second category 110 to provide a second instruction to the mover of the first category 105, to cause the mover of the first category 105 to take an action. The action can include following at least one command of the first category mover 105, following the first category mover 105, assisting the first category mover 105, directives to arrive to a set of coordinates, moving an object from a point A to a point B. The action can include the second category mover 110 taking on the role of a subordinate and the second category mover 110 assigning the first category mover 105 a supervisor role.

The system 100 (e.g. data processing system 115 components such as the processor(s) 120) can obtain a hierarchical rank assignment scheme. For example, the hierarchical assignment ranking scheme can include a hierarchical ranking. The hierarchical assignment rank scheme can overwrite previously assigned hierarchical rankings. The hierarchical assignment ranking scheme can include input from a local actor, a third party (e.g., a local party, a computer, a remote server), or from the input device 430 (e.g., of FIG. 4 among others). The hierarchical assignment rank scheme can represent hierarchical rankings for the first category mover 105 and the second category mover 110.

The system 100 (e.g. data processing system 115 components such as the processor(s) 120) can assign, based on the hierarchical ranking assignment scheme, a third hierarchical ranking to the mover of the first category 105 and a fourth hierarchical ranking to the mover of the second category 110. For example, the hierarchical ranking assignment scheme can include input from an input device 430 (e.g., of FIG. 4 among others). The hierarchical ranking assignment scheme can include a supervisor rank and a subordinate rank. The hierarchical ranking assignment scheme can include data from the database 130, or data from the memory 125.

The system 100 (e.g. one or more sensors 135) can obtain at least one position of the mover of the first category 105. For example, at least one sensor 135 can obtain the position of the mover of the first category 105 by using a camera equipped with object recognition software to detect and track the mover of the first category 105. At least one sensor 135 can obtain the position of the mover of the first category 105 by tracking the magnetic signature of the mover of the first category 105. At least one sensor 135 can obtain the position of the mover of the first category 105 by using a camera with image processing to recognize the mover of the first category 105 and calculating, using components of the system 100 such as the processor 120, the first category mover 105 position.

The system 100 (e.g. one or more sensors 135) can obtain at least one position of the mover of the second category 110. For example, at least one sensor 135 can obtain the position of the mover of the second category 110 by using a camera equipped with object recognition software to detect and track the mover of the second category 110. At least one sensor 135 can obtain the position of the mover of the second category 110 by tracking the magnetic signature of the mover of the second category 110. At least one sensor 135 can obtain the position of the mover of the second category 110 by using a camera with image processing to recognize the mover of the second category 110 and calculating, using components of the system 100 such as the processor 120, the second category mover 110's position.

The system 100 (e.g. data processing system 115 components such as the processor(s) 120) can assign, based on the position of the mover of the first category and the position of the mover of the second category, and the indication of the task, a third hierarchical ranking to the mover of the first category and a fourth hierarchical ranking to the mover of the second category. For example, the system 100 can assign hierarchical rankings based on the position of the mover of the first category 105 and the position of the mover of the second category 110. The system 100 can assign a third hierarchical ranking to the mover of the first category 105 and a fourth hierarchical ranking to the mover of the second category 110 when the mover of the first category 105 is closer to an assigned destination than the mover of the second category 110 is.

The system 100 (e.g. data processing system 115 components such as the processor(s) 120) can measure at least one parameter of the mover of the first category 105 and at least one parameter of the mover of the second category 110. For example, the system 100 can measure the parameter of the mover of the first category 105 and the parameter of the mover of the second category 110 using at least one sensor 135. The sensor 135 can measure the shape, weight, speed, or the capabilities of the mover of the first category 105. The sensor 135 can measure the shape, weight, speed, or the capabilities of the mover of the second category 110. The sensor 135 can measure the shape of a first category mover 105 and second category mover 110 by analyzing the movers with a camera equipped with object recognition software. The system 100 can measure the parameter of the mover of the first category 105 and the parameter of the mover of the second category 110 by analyzing the data provided by at least one sensor 135.

For example, the sensor 135 can measure the weight of the movers using a weight sensor. The sensor 135 can measure the speed of the movers using velocity sensors. The sensor 135 can measure the capabilities of the movers, such as the movers' maximum load capacity, maneuverability, durability, or operational limits. The movers' capabilities can be determined by analyzing data from sensor 135. Sensor 135 can include strain gauge sensors, accelerometers, gyroscopes, and pressure sensors in order to measure the stress, strain and gravitational force that movers such as the first category mover 105 and the second category mover 110 endure.

The system 100 (e.g. data processing system 115 components such as the processor(s) 120) can compare at least one parameter of the mover of the first category 105 and at least one parameter of the mover of the second category 110 with a threshold parameter to determine that the parameter of the mover of the first category 105 and the parameter of the mover of the second category 110 satisfies the threshold parameter. For example, the threshold parameter can include a load capacity of ten pounds, a speed of five miles per hour, a gravitational force of six pounds per square inch, and a shape that includes no edges. The threshold parameter can include the parameter of the first category mover 105 and the parameter of the second category mover 110. The system 100 can determine that the parameter of the mover of the first category mover 105 and the parameter of the mover of the second category 110 satisfies the threshold parameter by determining that the shape of the first category mover 105 and the second category mover 110 are the same shape as a shape provided to the system 100. The system 100 can determine that the parameter of the mover of the first category mover 105 satisfies the threshold parameter by determining that the first category mover's 105 maximum speed is above a provided, preset, or predetermined speed. The first category mover's 105 maximum speed can include or be twenty miles per hour, ten meters per second, or a tenth of a kilometer per minute. The preset speed can include or be ten miles per hour, five meters per second, or a fifth of a kilometer per minute. The system 100 can determine that the parameter of the mover of the first category mover 105 satisfies the threshold parameter by determining that the first category mover's 105 width is wider than a provided, preset, or predetermined width. The system 100 can determine that the parameter of the mover of the first category mover 105 satisfies the threshold parameter by determining the first category mover 105's load capacity is above a provided load capacity. The first category mover 105's load capacity can include a load capacity of twenty (20) pounds. The threshold parameter can include predefined limits such as a load capacity, speed limits, operational ranges, and shape constraints.

For example, the system 100 can determine that the parameter of the mover of the second category mover 110 satisfies the threshold parameter by determining that the second category mover's 110 maximum speed is above a provided, preset, or predetermined speed. The second category mover's 105 maximum speed can include or be twenty miles per hour, ten meters per second, or a tenth of a kilometer per minute. The provided, preset, or predetermined speed can include or be ten miles per hour, five meters per second, or a fifth of a kilometer per minute. The system 100 can determine that the parameter of the mover of the second category mover 110 satisfies the threshold parameter by determining that the second category mover's 105 width is wider than a provided, preset, or predetermined width. The system 100 can determine that the parameter of the mover of the second category mover 110 satisfies the threshold parameter by determining the second category mover 110's load capacity is above a provided load capacity. The second category mover 110's load capacity can include a load capacity of twenty (20) pounds.

The system 100 (e.g. data processing system 115 components such as the processor(s) 120) can assign, based on the comparison of the parameter of the mover of the first category 105 and the parameter of the mover of the second category 110 with a threshold parameter, a third hierarchical ranking of the mover of the first category 105 and an fourth hierarchical ranking the mover of the second category 110. For example, the system 100 can assign the third hierarchical ranking of the mover of the first category 105 and the fourth hierarchical ranking the mover of the second category 110 based on the comparison of the parameter of the mover of the first category 105 and the parameter of the mover of the second category 110 with a threshold parameter where a mover of the first category 105 gets assigned a third hierarchical ranking based on satisfying the threshold parameter and the mover of the second category 110 gets assigned the fourth hierarchical ranking based on not satisfying the threshold parameter.

For example, the system 100 can assign the third hierarchical ranking to the mover of the second category 110 and the fourth hierarchical ranking to the mover of the first category 105 based on the comparison of the parameter of the mover of the first category 105 and the parameter of the mover of the second category 110 with a threshold parameter where a mover of the second category 110 gets assigned a third hierarchical ranking based on satisfying the threshold parameter and the mover of the first category 105 gets assigned the fourth hierarchical ranking based on not satisfying the threshold parameter.

The system 100 (e.g. data processing system 115 components such as the processor(s) 120) can obtain at least one command instruction. The system 100 can obtain the command instruction directly from the processor 120, the data processing system 115, the computing device 140 from memory 125, or from database 130. For example, the system 100 can obtain the indication of a task for execution wirelessly or through a wired connection. For example, the command instruction can be associated with a third-party taking control of the first category mover 105 and the second category mover 110. The command instruction can be generated by the system 100 due to a change in parameters of the first category mover 105 and the second category mover 110. The command instruction can include instructions for the first category mover 105 and the second category mover 110 to follow all instructions coming from a computer,

The system 100 (e.g. data processing system 115 components such as the processor(s) 120) can provide, based on the command instruction, at least one instruction to the mover of the first category 105 and the mover of the second category 110 to cause the mover of the first category 105 and the mover of the second category 110 to follow (e.g., respond to) at least one control signal. For example, the movers can respond to the control signal by executing operations that cause the movers to respond to a control signal. The control signal can cause a facility where the first category mover 105 and the second category mover 110 are located in to take control of the first category mover 105 and the second category mover 110. The control signal can cause the system 100 (e.g., the data processing system 115) to take control of the first category mover 105 or the second category mover 110. The control signal can cause a high-level controller or programmable logic controller to take control of the first category mover 105 and the second category mover 110. The control signal can be outputted by a central controller, a high-level controller or programmable logic controller.

The system 100 (e.g. data processing system 115 components such as the processor(s) 120) can compare at least one parameter of the mover of the first category 105 and at least one parameter of the mover of the second category 110 with historical parameter data. For example, historical parameter data can include the shape, weight, speed, or the capabilities of movers. Historical parameter data can include how a first previous mover with the same parameters as the mover of the first category 105 and a second previous mover with the same parameters as the mover of the second category 110 interacted with each other in different environments. Historical parameter data can include computer simulation of movers interacting with each other such as the first category mover 105 and the second category mover 110 interacting with each other. Historical parameter data can include data inputted to the system 100 and stored in the database 130. The parameter data of the first category mover 105 and the second category mover 110 can be compared with historical parameter data in order to provide a hierarchical ranking assignment scheme recommendation based on the comparison.

The system 100 (e.g. data processing system 115 components such as the processor(s) 120) can provide, based on the comparison and the indication of the task, a hierarchical ranking assignment scheme. For example, the hierarchical ranking assignment scheme can include a method of ranking the first category mover 105 and the second category mover 110. The hierarchical ranking assignment scheme can include a ranking of the first category mover 105 and the second category mover 110. The hierarchical ranking assignment scheme can be based only on the comparison of the parameter of the mover of the first category 105 and the parameter of the mover of the second category 110 with historical parameter data or only on the indication of the task. The hierarchical ranking assignment scheme can be based on the comparison, the indication of the task, the parameter of the first category mover 105, or the parameter of the second category mover 110. The hierarchical ranking assignment scheme can include ranks based on data received from the processors 120, input device 430 (e.g., of FIG. 4 among others), sensors 135, and data processing system 115.

The system 100 (e.g. data processing system 115 components such as the processor(s) 120) can assign, based on the hierarchical ranking assignment scheme, a hierarchical ranking to the mover of the first category 105 and the mover of the second category 110. For example, the assignment of the hierarchical ranking based on the hierarchical ranking assignment scheme can include an assignment of a first hierarchical ranking to the mover of the first category 105 and an assignment of a second hierarchical ranking to the mover of the second category 110.

The system 100 (e.g. data processing system 115 components such as the processor(s) 120) can detect at least one fault condition. For example, the fault condition can include that the first category mover 105 or the second category 110 is slowing down under a threshold level of speed. The fault condition can include when the first category mover 105 or the second category mover 110 runs into an object or structure. The fault condition can include when the first category mover 105 or the second category mover 110 is damaged. The fault condition can include when the first category mover 105 or the second category mover 110 stops communicating with the system 100. The fault condition can include when the first category mover 105 is unable to communicate with the second category mover 110. The system 100 can detect a fault condition using sensors 135. Sensor 135 can detect the fault condition by using cameras to identify the location of the first category mover 105 relative to the second category mover 110. Sensor 135 can detect a fault condition by using a crash sensor located on the first category mover 105 or the second category mover 110 to detect an impact. Sensor 135 can detect a fault condition by measuring the speed of the first category mover 105 in relation to the second category mover 110. Sensor 135 can detect a fault condition by analyzing the shape of the first category mover 105 or second category mover 110 and determine if the first category mover 105 or second category mover 110 are misshapen.

The system 100 (e.g. data processing system 115 components such as the processor(s) 120) can assign, based on at least one fault condition, and at least one indication of the task, a third hierarchical ranking to at least one mover of the first category and a fourth hierarchical ranking to at least one mover of the second category. For example, the system 100 can assign a third hierarchical ranking to the mover of the first category and a fourth hierarchical ranking to the mover of the second category where the third hierarchal ranking can indicate a supervisor role, and the fourth hierarchical ranking can indicate a subordinate role. The third hierarchal ranking can indicate a subordinate role, and the fourth hierarchical ranking can indicate a supervisor role. The system 100 can assign a subordinate role to the first category mover 105 and a supervisor role to the second category mover 110 when the system 100 detects that the first category mover 105 has a fault condition and the second category mover 110 does not have a fault condition. The system 100 can assign a subordinate role to the second category mover 110 and a supervisor role to the first category mover 105 when the system 100 detects that the second category mover 110 has a fault condition and the first category mover 105 does not have a fault condition.

The system 100 (e.g. data processing system 115 components such as the processor(s) 120) can adjust, based on the fault condition, at least one mover of the first category 105 and at least one mover of the second category 110. The system 100 can adjust the mover of the first category 105 and the mover of the second category 110 by slowing down the mover of the first category 105 when the mover of the second category 110 has a fault condition causing the mover of the second category 110 to slow down. The system 100 can slow down the mover of the first category 105 by sending a signal to the first category mover 105 to slow down. The system 100 can adjust the mover of the first category 105 or the mover of the second category 110 by taking control of the mover of the first category 105 or the mover of the second category 110. The system 100 can adjust the mover of the first category 105 or the mover of the second category 110 by the system 100 replacing the mover of the first category 105 or the mover of the second category 110 with another mover. The system 100 can adjust the mover of the first category 105 or the mover of the second category 110 by taking remedial action to fix the fault condition. The remedial action can include resetting a mover, fixing a mover, establishing communication between movers, or shutting a mover down.

The system 100 (e.g. data processing system 115 components such as the processor(s) 120) can detect the position of the mover of the first category 105. The system 100 can detect the position of the first category mover 105 by analyzing data provided by at least one sensor 135. Sensor 135 can provide data of the position of the first category mover 105 by using a camera equipped with object recognition software to detect where the first category mover 105 is located. Sensor 135 can detect the position of the first category mover 105 by using. At least one sensor 135 can detect the position of the mover of the first category 105 by using a camera equipped with object recognition software to detect and track the mover of the first category 105. At least one sensor 135 can detect the position of the mover of the first category 105 by tracking the magnetic signature of the mover of the first category 105. At least one sensor 135 can detect the position of the mover of the first category 105 by using a camera with image processing to recognize the mover of the first category 105 and calculating, using components of the system 100 such as the processor 120, the first category mover 105 position.

The system 100 (e.g. data processing system 115 components such as the processor(s) 120) can detect at least one position of the mover of the second category 110. The system 100 can detect the position of the second category mover 110 by analyzing data provided by at least one sensor 135. Sensor 135 can provide data of the position of the second category mover 110 by using a camera equipped with object recognition software to detect where the second category mover 110 is located. Sensor 135 can detect the position of the second category mover 110 by using a LiDAR camera. Sensor 135 can detect the position of the second category mover 110 by using. At least one sensor 135 can detect the position of the mover of the second category 110 by using a camera equipped with object recognition software to detect and track the mover of the second category 110. At least one sensor 135 can detect the position of the mover of the second category 110 by tracking the magnetic signature of the mover of the second category 110. At least one sensor 135 can detect the position of the mover of the second category 110 by using a camera with image processing to recognize the mover of the second category 110. The system 100 can calculate, using components of the system 100 such as the processor 120 and data from the sensor 135, the second category mover 110 position.

The system 100 (e.g. data processing system 115 components such as the processor(s) 120) can determine that the mover of the first category 105 and the mover of the second category 110 are in positions based on hierarchical assignments of the mover of the first category 105 and the mover of the second category 110. For example, the positions based on hierarchical assignments can include the mover of the first category 105 being ahead of the mover of the second category 110 due to the mover of the first category 105 having a hierarchical assignment of supervisor and the mover of the second category 110 having a hierarchical assignment of subordinate. For example, the positions based on hierarchical assignments can include the mover of the second category 110 being ahead of the mover of the first category 105 due to the mover of the second category 110 having a hierarchical assignment of supervisor and the mover of the first category 105 having a hierarchical assignment of subordinate.

For example, the mover of the first category 105 and the mover of the second category 110 are in positions based on their hierarchical assignments when the mover of the first category 105 is ahead of the mover of the second category 110 and the mover of the first category 105 is assigned a hierarchical ranking that is above the hierarchical ranking the mover of the second category 110 is assigned. For example, the mover of the first category 105 and the mover of the second category 110 are in positions based on their hierarchical assignments when the mover of the second category 110 is ahead of the mover of the first category 105 and the mover of the second category 110 is assigned a hierarchical ranking that is above the hierarchical ranking the mover of the first category 105 is assigned.

The system 100 can include at least one first category mover 105 where the first category mover 105 is a track-based mover. For example, the first category mover 105 can travel via track. The first category mover 105 can include independent cart technology (ICT)-based movers, conveyer-based movers, linear motor movers, independent cart technology (ICT)-based movers using linear synchronous motor (LSM) technology, or any other track-based movers. The first category mover 105 can travel via rail, magnetism, or conveyor. The first category mover 105 can include gliding or rolling contact with a track. The first category mover 105 can travel around a track. The first category mover 105 can independently move around a track. The first category mover 105 can move bidirectionally or unidirectionally around a track. The first category mover 105 can communicate with other first category movers 105. Multiple first category movers 105 can be present and in motion on a track concurrently, travelling to and from the same or different origins or destinations. The first category mover 105 can be programmed to be autonomous. The first category mover 105 can include motors. The first category mover 105 can include a hall effect sensor. The first category mover 105 can magnetically glide across a track. The first category mover 105 can roll across a track.

The system 100 can include at least one second category mover 110 where the second category mover 110 is a non-track-based mover. For example, the second category mover 110 can include an independent moving vehicle, automated guided vehicles (AGV), autonomous mobile robots (AMR), linear motor movers, or an automated guided vehicles (AGV) using linear synchronous motor (LSM) technology. The second category mover 110 can be autonomous or remote controlled.

The system 100 can include at least one first category mover 105 where the first category mover 105 is a non-track-based mover. For example, the first category mover 105 can include an independent moving vehicle, automated guided vehicles (AGV), autonomous mobile robots (AMR), linear motor movers, or an automated guided vehicles (AGV) using linear synchronous motor (LSM) technology. The first category mover 105 can be autonomous or remote controlled.

The system 100 can include at least one second category mover 110 where the second category mover 110 is a track-based mover. For example, the second category mover 110 can go travel via track. The second category mover 110 can include independent cart technology (ICT)-based movers, conveyer-based movers, linear motor movers, independent cart technology (ICT)-based movers using linear synchronous motor (LSM) technology, or any other track-based movers. The second category mover 110 can travel via rail, magnetism, or conveyor. The second category can include gliding or rolling contact with a track. The second category mover 110 can travel around a track. The second category mover 110 can independently move around the track. The second category mover 110 can move bidirectionally or unidirectionally around a track. The second category mover 110 can communicate with other second category movers 110. Multiple second category movers 110 can be present and in motion on a track concurrently, travelling to and from the same or different origins or destinations. The second category mover 110 can be programmed to be autonomous. The second category mover 110 can include motors. The second category mover 110 can include a hall effect sensor. The second category mover 110 can magnetically glide across a track. The second category mover 110 can roll across a track.

The system 100 (e.g. data processing system 115 components such as the processor(s) 120) can synchronize the operation of the mover of the first category 105 with the operation of the mover of the second category 110 based on the location, weight, speed, timing, shape, or constraints of the mover of the first category 105 and the location, weight, speed, timing, shape, or constraints of the mover of the second category. For example, the system 100 can synchronize the operation of the mover of the first category 105 with the operation of the mover of the second category 110 by establishing a link between the mover of the first category 105 and the mover of the second category 110. The link enables the mover of the first category 105 and the mover of the second category 110 to communicate and follow one another. The system 100 can synchronize the operation of the mover of the first category 105 and the mover of the second category 110 based on the location of the mover of the first category 105 and the location of the mover of the second category 110. The system 100 can adjust the speed or trajectory of the mover of the second category 110 to ensure synchronized arrival at the destination when the location of the mover of the first category 105 is closer to an assigned destination than the location of the mover of the second category 110. The system 100 can adjust the speed or trajectory of the mover of the first category 105 to ensure synchronized arrival at the destination when the location of the mover of the second category 110 is closer to an assigned destination than the location of the mover of the first category 105. The system 100 can synchronize the operation of the mover of the first category 105 with the operation of the mover of the second category 110 by adjusting the movers' movements based on the weight of the mover of the first category 105 and the weight of the mover of the second category 110. The system 100 can synchronize the operation of the mover of the first category 105 with the operation of the mover of the second category 110 by coordinating the movements of the first category mover 105 sand the second category mover 110 based on the timing of the actions of the first category mover 105 and the timing of the actions of the second category mover 110. The system 100 can synchronize the operation of the mover of the first category 105 with the operation of the mover of the second category 110 by aligning their movements based on the shape of the mover of the first category 105 and the shape of the mover of the second category 110 to coordinate task execution. The system 100 can direct the movers along specific paths when it determines that both movers will fit. The system 100 can synchronize the operation of the mover of the first category 105 with the operation of the mover of the second category 110 by coordinating their movements based on the constraints of the mover of the first category 105 and the constraints of the mover of the second category 110, allowing for coordinated task execution. For example, the constraints can include the maximum load capacity, operational speed limits, maneuverability, and environmental conditions such as temperature and humidity tolerance. The system 100 can utilize sensor data provided by sensor 135 to monitor and adjust the parameters of the first category mover 105 and the second category mover 110 to maintain synchronization of the movers.

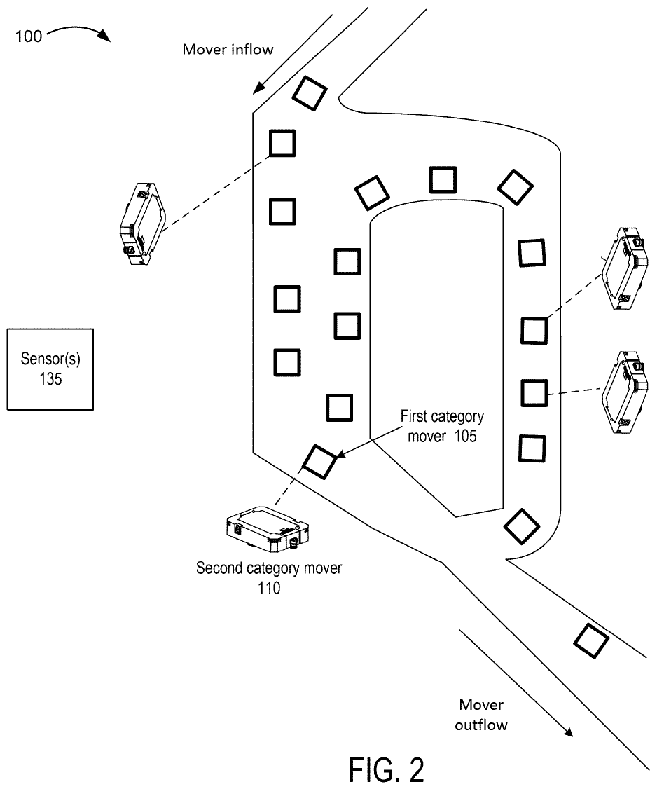

FIG. 2 illustrates an example system 100 of hierarchical mover subordination. The system 100 can include a first category mover 105 and a second category mover 110. For example, the first category mover 105 can have a virtual link to the second category mover 110. The virtual link can include a wireless communication path, an optical link, or a hybrid of a wireless and wired link. The first category mover can have a hierarchical ranking corresponding to a supervisor position and the second category mover 110 can have a hierarchical ranking corresponding to subordinate position. The second category mover 110 can have a hierarchical ranking corresponding to a supervisor position and the first category mover 105 can have a hierarchical ranking corresponding to a subordinate position.

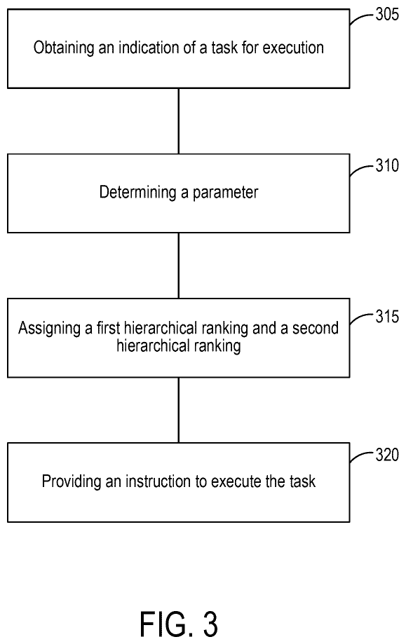

FIG. 3 depicts a method 300 of hierarchical mover subordination. The method 300 can include obtaining at least one indication of a task for execution (ACT 305). For example, the task for execution can be obtained from the input received from a computing device 140, from a local computer network, from a local actor (e.g., an individual providing input using the computing device 140, or the input device 430 (e.g., of FIG. 4 among others)), from an online network (e.g., a network connected to the internet), or a local database (e.g., database 130). The system 100, the one or more processors 120, the data processing system 115, the first category mover 105, the second category mover 110, or the sensor 135 can obtain the indication of a task for execution.

The method 300 can include determining at least one parameter (ACT 310). For example, the parameter can be determined by the sensor 135. The parameter can be determined by the one or more processors 120, or the data processing system 115 analyzing data provided by the sensor 135. The parameter can be determined by the sensor 135 analyzing the first category mover 105 and the second category mover 110. The sensor 135 can analyze the first category mover 105 and the second category mover 110 using a camera, a laser sensor, a scanner, a scale, a weight sensor, or an object recognizing sensor. The parameter can be determined by the mover of the first category 105 or the mover of the second category 110.

The method 300 can include assigning a first hierarchical ranking and a second hierarchical ranking (ACT 315). For example, the first hierarchical ranking and the second hierarchical ranking can be assigned by associating the first category mover's 105 or the second category mover's 110 shape with the hierarchical ranking. The sensor 135 can analyze a mover's shape in order to associate it with a hierarchical ranking. The data processing system 115 can assign a first hierarchical ranking and a second hierarchical ranking to the mover of the first category 105 and the mover of the second category 110 using data from the sensor 135. The data processing system 115 can assign a first hierarchical ranking and a second hierarchical ranking to the mover of the first category 105 and the mover of the second category 110 by associating a scannable code on the mover of the first category 105 and the mover of the second category 110 with a first and second hierarchical rank.

The method 300 can include providing an instruction to execute the task (ACT 320). For example, the one or more processors, the system, the first category mover 105, the second category mover 110, a third-party computer system, the computing device 140, an input device 140, and data processing system 115 can provide the instruction to execute the task. The instruction to execute the task can be provided wirelessly, or through a wired connection. The instruction to execute the task can be provided to the mover of the first category 105 or the mover of the second category 110. The instruction to execute the task can be provided in parts. The instruction to execute the task can be provided from a mobile device, via graphical user interface (GUI), or through a sensor 135 trigger.

FIG. 4 illustrates a block diagram of an example computing system 400, also referred to as a computer system 400. The computing system 400 can include, included by, or be used to implement a data processing system 115. The computing system 400 includes at least one bus 405 or other communication component for communicating information and at least one processor 120 (e.g., of FIG. 1 among others). or processing circuit coupled to the bus 405 for processing information. The computing system 400 can also include one or more processors 120 or processing circuits coupled to the bus for processing information. The computing system 400 also includes at least one memory 125 (e.g., of FIG. 1 among others), such as a random-access memory (RAM) or other dynamic storage device, coupled to the bus 405 for storing information, and instructions to be executed by the processor 120. The memory 125 can be used for storing information during execution of instructions by the processor 120. The computing system 400 may further include at least one read only memory (ROM) 415 or other static storage device coupled to the bus 405 for storing static information and instructions for the processor 120. A storage device 420, such as a solid-state device, magnetic disk, or optical disk, can be coupled to the bus 405 to persistently store information and instructions.

The computing system 400 may be coupled via the bus 405 to an output device 425, such as a liquid crystal display, or active-matrix display, for displaying information to a user. An input device 430, such as a keyboard or voice interface may be coupled to the bus 405 for communicating information and commands to the processor 120. The input device 430 can include a touch screen display. The input device 430 can also include a cursor control, such as a mouse, a trackball, or cursor direction keys, for communicating direction information and command selections to the processor 120 and for controlling cursor movement on the output device 425, such as a display.

The processes, systems and methods described herein can be implemented by the computing system 400 in response to the processor 120 executing an arrangement of instructions contained in memory 125. Such instructions can be read into memory 125 from another computer-readable medium, such as the storage device 420. Execution of the arrangement of instructions contained in memory 125 causes the computing system 400 to perform the illustrative processes described herein. One or more processors in a multi-processing arrangement may also be employed to execute the instructions contained in memory 125. Hard-wired circuitry can be used in place of or in combination with software instructions together with the systems and methods described herein. Systems and methods described herein are not limited to any specific combination of hardware circuitry and software.

While operations can be depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

Having now described some illustrative implementations, it is apparent that the foregoing is illustrative and not limiting, having been provided by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A system of hierarchical mover subordination, comprising:
a mover of a first category;
a mover of a second category;
one or more processors, coupled with memory, to:
obtain an indication of a task for execution by the mover of the first category and the mover of the second category;
determine a parameter of the mover of the first category and a parameter of the mover of the second category;
assign, based on the parameter of the mover of the first category, the parameter of the mover of the second category, and the indication of the task, a first hierarchical ranking to the mover of the first category and a second hierarchical ranking to the mover of the second category; and
provide an instruction to the mover of the first category to execute the task, the instruction to the mover of the first category to cause the mover of the first category to provide an instruction to the mover of the second category, to cause the mover of the second category to take an action.

2. The system of claim 1, wherein the instruction of the mover of the first category is a first instruction, comprising:
the one or more processors coupled with memory to:
provide a second instruction to the mover of the second category to execute a second task.

3. The system of claim 1, comprising:
the one or more processors coupled with memory to:
obtain a hierarchical ranking assignment scheme; and
assign, based on the hierarchical ranking assignment scheme, a third hierarchical ranking to the mover of the first category and a fourth hierarchical ranking to the mover of the second category.

4. The system of claim 1, comprising one or more sensors to:
obtain a position of the mover of first category;
obtain a position of the mover of the second category; and
the one or more processors coupled with memory to:
assign, based on the position of the mover of the first category and the position of the mover of the second category, and the indication of the task, a third hierarchical ranking to the mover of the first category and a fourth hierarchical ranking to the mover of the second category.

5. The system of claim 1, comprising:
the one or more processors coupled with memory to:
measure the parameter of the mover of the first category and the parameter of the mover of the second category;
compare the parameter of the mover of the first category and the parameter of the mover of the second category with a threshold parameter; and
assign, based on the comparison of the parameter of the mover of the first category and the parameter of the mover of the second category with a threshold parameter, a third hierarchical ranking to the mover of the first category and a fourth hierarchical ranking to the mover of the second category.

6. The system of claim 1, comprising:
the one or more processors coupled with memory to:
obtain a command instruction; and
provide, based on the command instruction, an instruction to the mover of the first category and the mover of the second category to cause the mover of the first category and the mover of the second category to respond to a control signal.

7. The system of claim 1, comprising:
the one or more processors coupled with memory to:
measure the parameter of the mover of the first category and the parameter of the mover of the second category;
compare the parameter of the mover of the first category and the parameter of the mover of the second category with historical parameter data;
provide, based on the comparison and the indication of the task, a hierarchical ranking assignment scheme; and
assign, based on the hierarchical ranking assignment scheme, a third hierarchical ranking to the mover of the first category and a fourth hierarchical ranking to the mover of the second category.

8. The system of claim 1, comprising:
the one or more processors coupled with memory to:
detect a fault condition; and
assign, based on the fault condition, and the indication of the task, a third hierarchical ranking to the mover of the first category and a fourth hierarchical ranking to the mover of the second category.

9. The system of claim 1, comprising:
the one or more processors coupled with memory to:
detect a fault condition; and
adjust, based on the fault condition, the mover of the first category or the mover of the second category.

10. The system of claim 1, comprising:
the one or more processors coupled with memory to:
detect a position of the mover of the first category;
detect a position of the mover of the second category; and
determine that the mover of the first category and the mover of the second category are in positions based on the hierarchical assignments of the mover of the first category and the mover of the second category.

11. The system of claim 1, comprising:
the mover of the first category is a track-based mover; and
the mover of the second category is a non-track-based mover.

12. The system of claim 1, comprising:
the mover of the first category is a non-track-based mover; and
the mover of the second category is a track-based mover.

13. The system of claim 1, comprising:
synchronize an operation of the mover of the first category with an operation of the mover of the second category based on a location, weight, speed, timing, shape, or constraints of the mover of the first category and a location, weight, speed, timing, shape, or constraints of the mover of the second category.

14. A method, comprising:
a mover of a first category;
a mover of a second category;
obtaining, by one or more processors, an indication of a task for execution by the mover of the first category and the mover of the second category;
determining, by one or more processors, a parameter of the mover of the first category and a parameter of the mover of the second category;
assigning, by one or more processors, based on the parameter of the mover of the first category, the parameter of the mover of the second category, and the indication of the task, a first hierarchical ranking to the mover of the first category and a second hierarchical ranking to the mover of the second category; and
providing, by one or more processors, an instruction to the mover of the first category to execute the task, the instruction to the mover of the first category to execute the task to cause the mover of the first category to provide an instruction to the mover of the second category, to cause the mover of the second category to take an action.

15. The method of claim 14, comprising:
obtaining, by one or more processors, a hierarchical ranking assignment scheme;
and assigning, by one or more processors, based on the hierarchical ranking assignment scheme, a third hierarchical ranking to the mover of the first category and a fourth hierarchical ranking to the mover of the second category.

16. The method of claim 14, comprising:
obtaining, by one or more sensors, a position of the mover of the first category;
obtaining, by one or more sensors, a position of the mover of the second category; and
assigning, by one or more processors, based on the position of the mover of the first category and the mover of the second category, and the indication of the task, a third hierarchical ranking to the mover of the first category and a fourth hierarchical ranking to the mover of the second category.

17. The method of claim 14, comprising:
measuring, by one or more processors, the parameter of the mover of the first category and the parameter of the mover of the second category;
comparing, by one or more processors, the parameter of the mover of the first category and the parameter of the mover of the second category with a threshold parameter to determine that the parameter of the mover of the first category and the parameter of the mover of the second category satisfies the threshold parameter; and
assigning, by one or more processors, based on the comparison of the parameter of the mover of the first category and the parameter of the mover of the second category with a threshold parameter, a third hierarchical ranking to the mover of the first category and a fourth hierarchical ranking to the mover of the second category.

18. The method of claim 14, comprising:
obtaining, by one or more processors, a command instruction; and
providing, by one or more processors, based on the command instruction, an instruction to the mover of the first category and the mover of the second category to respond to a control signal.

19. The method of claim 14, comprising:
detecting, by one or more processors, a fault condition; and
assigning, by one or more processors, based on the fault condition, and the indication of the task, a third hierarchical ranking to the mover of the first category and a fourth hierarchical ranking to the mover of the second category.

20. The method of claim 14, comprising:
synchronizing, by one or more processors, an operation of the mover of the first category with an operation of the mover of the second category based on a location, weight, speed, timing, shape, or constraints of the mover of the first category and based on a location, weight, speed, timing, shape, or constraints of the mover of the second category.
